(19) United States
(12) Patent Application Publication
(10) Pub. No.: US 2011/0235178 A1
(43) Pub. Date: Sep. 29, 2011

(54) DIFFRACTIVE OPTICAL ELEMENT AND OPTICAL DEVICE

(76) Inventors: Kazuhiro MINAMI, Osaka (JP); Kazuhiro Yamada, Osaka (JP)

(21) Appl. No.: 13/071,686

(22) Filed: Mar. 25, 2011

(30) Foreign Application Priority Data
Mar. 26, 2010 (JP) 2010-071962
Mar. 15, 2011 (JP) 2011-056788

(51) Int. Cl. G02B 5/18

(52) U.S. Cl. 359/566

(57) ABSTRACT

A diffractive optical element includes first and second optical members which are stacked. A diffraction grating is formed at an interface between the first and second optical members. A plurality of pores are formed in the second optical member.

### CROSS-REFERENCE TO RELATED APPLICATION

This application claims priority to Japanese Patent Application No. 2010-071962 filed on Mar. 26, 2010 and Japanese Patent Application No. 2011-056788 filed on Mar. 15, 2011, the disclosure of which including the specification, the drawings, and the claims is hereby incorporated by reference in its entirety.

### BACKGROUND

A technique disclosed herein relates to a diffractive optical element in which two optical members are stacked, and a diffraction grating is formed at an interface between the two optical members, and to an optical device including the diffractive optical element.

A diffractive optical element has been known, in which a plurality of optical members are stacked, and a relief pattern is formed at an interface between the optical members (see Japanese Patent Publication No. H09-127321).

In a diffractive optical element described in, e.g., Japanese Patent Publication No. H09-127321, a plurality of optical members are stacked, and diffraction gratings having a saw-tooth cross section are formed at an interface between the optical members. More specifically, one of the diffraction gratings is configured so that a plurality of ridge-like raised portions each having a vertical wall and a wall inclined to the vertical wall are arranged at a predetermined pitch, and the other diffraction grating is configured so that a plurality of valley-like recessed portions to be engaged with the raised portions are arranged at the same pitch as that between the raised portions.

In order to realize a desired optical performance, it is necessary that the plurality of optical members of the foregoing diffractive optical element are made of suitable optical materials. That is, a combination of the optical materials to be stacked is important. However, kinds of the optical material are limited, and a degree of freedom when selecting the optical material having suitable optical constants are not so high.

As one method for increasing the degree of freedom of the material selection, there is nanocomposite technology for mixing inorganic particulates with optical material as disclosed in Japanese Patent Publication No. 2009-073166. The mixing inorganic particulates with optical material adjusts optical constants.

### SUMMARY

However, in the nanocomposite technology, it is necessary that the size of the inorganic particulate is smaller than a wavelength to be used for the diffractive optical element. Thus, there are problems such as difficulty in manufacturing.

In addition, there is another problem that the nanocomposite technology is not effective for a diffractive optical element in which an optical member made of glass and an optical member made of resin are stacked. That is, the particulates are easily mixed with resin as compared to glass, and therefore the particulates tend to be mixed with the optical member made of resin. Consequently, an effective refractive index of the optical member made of resin is increased. In the diffractive optical element, a larger refractive index difference between the two materials results in a lower height of a diffraction grating. If the difference in level of the diffraction grating is smaller, an optical performance can be maintained even when light obliquely enters the diffraction grating. However, if the effective refractive index of the optical member made of resin is increased as described above, the refractive index difference between the two materials is decreased, and therefore the difference in level of the diffraction grating should be increased. Consequently, the optical performance is degraded when light obliquely enters the diffraction grating. As in such a case, the nanocomposite technology is not so effective for the diffractive optical element in which the optical member made of glass and the optical member made of resin are stacked.

The technique disclosed herein has been made in view of the foregoing, and it is an objective of the technique to facilitate material selection of a diffractive optical element by a method other than the nanocomposite technology.

In order to solve the foregoing problems, a diffractive optical element includes a first optical member in which a diffraction grating is formed; and a second optical member in which a diffraction grating is formed. The first and second optical members are arranged in a state in which the diffraction gratings of the first and second optical members face each other, and the second optical member includes a plurality of pores. The stacking of the first and second optical members is not limited to a case where the first and second optical members are directly stacked in close contact with each other, and includes a case where the first and second optical members are stacked in a state in which an intermediate layer such as air, an antireflection film, and an adhesive is interposed between the first and second optical members.

According to the diffractive optical element, the pores are formed in the optical member, thereby changing an effective refractive index to any values. Thus, the material selection of the diffractive optical element can be facilitated.

### BRIEF DESCRIPTION OF THE DRAWINGS

FIG. 1 is a schematic view of a camera to which an interchangeable lens of a first embodiment is attached.

FIG. 2 is a schematic cross-sectional view of a diffractive optical element.

FIG. 3(a) is a graph illustrating combinations of first and second optical members, which are selected so as to satisfy an inter-material gradient M. FIG. 3(b) is a graph illustrating a change in optical constant by providing pores in the optical member.

FIG. 4 is a schematic cross-sectional view of a diffractive optical element of a second embodiment.

FIG. 5 is a schematic cross-sectional view of a diffractive optical element of a third embodiment.

FIG. 6 is a schematic cross-sectional view of a diffraction grating.

FIG. 7 is a graph illustrating diffraction efficiency of a diffractive optical element of a first comparative example.

FIG. 8 is a graph illustrating diffraction efficiency of a diffractive optical element of example 1-1.

FIG. 9 is a graph illustrating diffraction efficiency of a diffractive optical element of example 1-2.

FIG. 10 is a graph illustrating diffraction efficiency of the diffractive optical element of the second example.

FIG. 11 is a graph illustrating diffraction efficiency of a diffractive optical element of a third example.

FIG. 12 is a graph illustrating diffraction efficiency of a diffractive optical element of a fourth example.

FIG. 13 is a graph illustrating diffraction efficiency of a diffractive optical element of a fifth example.

FIG. 14 is a schematic view illustrating a grating height h when a shape of the diffraction grating is non-uniform.

### DETAILED DESCRIPTION

Embodiments of the present disclosure will be described below in detail with reference to the drawings.

### First Embodiment

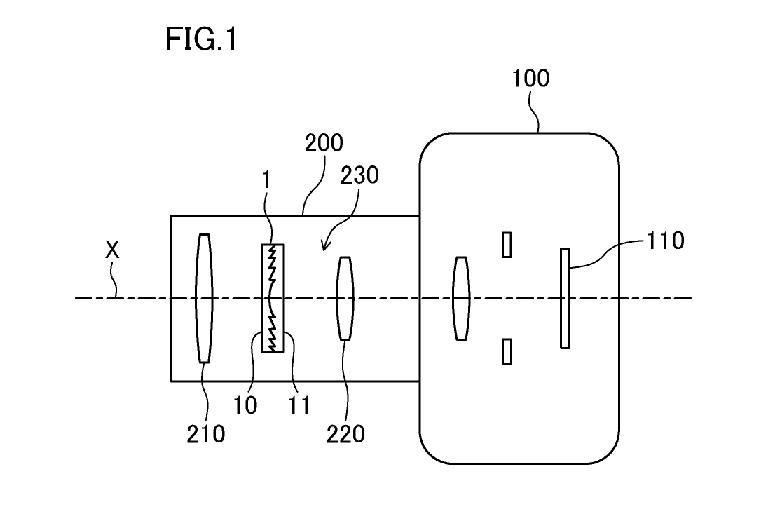

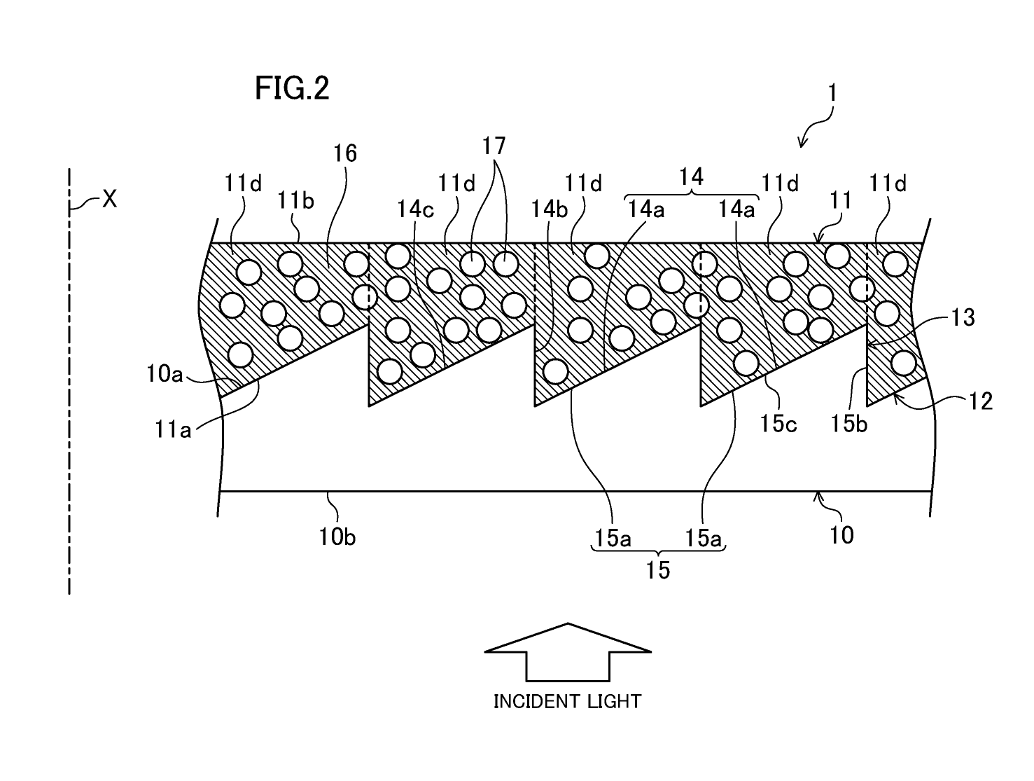

FIG. 1 is a schematic view of an interchangeable lens 200 including a diffractive optical element 1 of an example embodiment, and a camera 100 to which the interchangeable lens 200 is attached. FIG. 2 is a schematic cross-sectional view of the diffractive optical element 1.

The interchangeable lens 200 is detachable from the camera 100. The interchangeable lens 200 is, e.g., a telephoto zoom lens. In the interchangeable lens 200, the diffractive optical element 1 serves as a lens element in addition to refractive lenses 210, 220. The refractive lenses 210, 220 and the diffractive optical element 1 together form an optical imaging system 230 configured to focus light bundles on an imaging element 110 of the camera 100. The interchangeable lens 200 or the camera 100 including the interchangeable lens 200 forms an optical device.

The diffractive optical element 1 is a close-contact type multilayer diffractive optical element in which a first optical member 10 and a second optical member 11 having light transmission properties are stacked. In the present embodiment, the first optical member 10 is made of glass material, and the second optical member 11 is made of resin material. The second optical member 11 is made of porous resin having a plurality of pores. A configuration of the second optical member 11 will be described in detail later. The first optical member 10 and the second optical member 11 are bonded together.

A diffraction grating 13 having a saw-tooth cross section is formed at an interface 12 defined by a bonding surface 10a of the first optical member 10 and a bonding surface 11a of the second optical member 11. Optical power of the diffraction grating 13 has wavelength dependency. Thus, the diffraction grating 13 provides the substantially same phase difference to light having different wavelengths, and diffracts the light having different wavelengths at diffraction angles which are different from each other. The diffraction grating 13 is formed of a first diffraction grating 14 which is formed in raised shape in the bonding surface 10a of the first optical member 10, and a second diffraction grating 15 which is formed in recessed shape in the bonding surface 11a of the second optical member 11.

Specifically, the first diffraction grating 14 includes a plurality of ridge-like raised portions 14a which extend in a circumferential direction around an optical axis X of the diffractive optical element 1, and which are concentrically and regularly arranged around the optical axis X. Each of the raised portions 14a has a vertical surface 14b which is substantially parallel to the optical axis X (i.e., extends along the optical axis X), and an inclined surface 14c which is inclined to the optical axis X (i.e., inclined to the vertical surface 14b). Each of the raised portions 14a has a substantially triangular cross section.

The second diffraction grating 15 includes a plurality of valley-like recessed portions 15a which extend in the circumferential direction around the optical axis X of the diffractive optical element 1, and which are concentrically and regularly arranged around the optical axis X. Each of the recessed portions 15a has a vertical surface 15b which is substantially parallel to the optical axis X, and an inclined surface 15c which is inclined to the optical axis X. Each of the recessed portions 15a has a substantially triangular cross section.

The first diffraction grating 14 and the second diffraction grating 15 have the same grating height and the same grating pitch. That is, the raised portions 14a of the first diffraction grating 14 are exactly fitted into the recessed portions 15a of the second diffraction grating 15. Consequently, the bonding surface 10a of the first optical member 10 and the bonding surface 11a of the second optical member 11 contact each other without clearances, thereby defining the single interface 12. The first diffraction grating 14 and the second diffraction grating 15 together form the diffraction grating 13. Note that, if the bonding surface 10a and the bonding surface 11a are substantially parallel to each other, an intermediate layer such as air, an antireflection film, and an adhesive, which has a refractive index different from those of the first diffraction grating 14 and the second diffraction grating 15 may be interposed between the bonding surface 10a and the bonding surface 11a.

The inclined surface 14c of the raised portion 14a of the first diffraction grating 14 and the inclined surface 15c of the recessed portion 15a of the second diffraction grating 15 may be curved so as to define an aspherical or spherical surface.

A surface 10b of the first optical member 10 on an opposite side of the bonding surface 10a, and a surface 11b of the second optical member 11 on an opposite side of the bonding surface 11a are formed into flat surfaces parallel to each other. As illustrated in FIG. 1, e.g., light entering the diffractive optical element 1 from the first optical member 10 side is diffracted at the diffraction grating 13 to exit to the second optical member 11 side. Note that the surface 10b of the first optical member 10 and the surface 11b of the second optical member 11 may not be parallel to each other. In addition, the surface 10b of the first optical member 10 and the surface 11b of the second optical member 11 may not be flat, and may be curved so as to define an aspherical or spherical surface.

In the second optical member 11, a plurality of closed pores 17 are dispersed in a resin layer 16. The closed pore 17 is formed in substantially spherical shape. In the resin layer 16, the plurality of closed pores 17 are not necessarily isolated from each other, and some of the closed pores 17 are coupled to each other. Some of the spherical closed pores 17 may have an incomplete spherical shape. The closed pore 17 is filled with gas (e.g., air and carbon dioxide). That is, the closed pores 17 are formed with air bubbles. The closed pore 17 is one example of the pore.

Since the plurality of closed pores 17 are formed in the second optical member 11, optical constants of the second optical member 11 are changed. Specifically, the formation of the plurality of closed pores 17 in the second optical member 11 can reduce an effective refractive index of the second optical member 11 as compared to a case where the closed pores 17 are not formed. As will be described in detail later, this broadens a range of material selection of the second optical member 11 and the first optical member 10, which is applicable to the diffractive optical element 1.

An average diameter of the closed pores 17 is preferably less than or equal to about 1/20 of the shortest wavelength in a wavelength range of incident light targeted for the diffractive optical element 1. For example, if a target wavelength of the diffractive optical element 1 is about 400-700 nm, the average diameter of the closed pores 17 is preferably less than or equal to about 20 nm. According to such a configuration, light scattering can be reduced when light enters the second optical member 11. Alternatively, greater than or equal to about 95% of the closed pores 17 contained in the second optical member 11 preferably have the diameter of less than or equal to about 1/20 of the shortest wavelength of the target wavelength of the diffractive optical element 1. According to such a configuration, the light scattering can be also reduced when light enters the second optical member 11.

The plurality of closed pores 17 are uniformly dispersed in the resin layer 16 of the second optical member 11. That is, the plurality of closed pores 17 are not concentrated on one portion of the resin layer 16. Specifically, in a case where the second optical member 11 is divided into a plurality of regions 11d corresponding to unit structures (i.e., the recessed portions 15a) of the second diffraction grating 15 along cylindrical planes concentric with the optical axis, if, in two adjoining regions 11d, a volume ratio of the closed pores 17 to one of the regions 11d is “p1,” and a volume ratio of the closed pores 17 to the other region 11d is “p2,” the following expression (1) is preferably satisfied:

0.9×p2<p1<1.1×p2 (1)

By satisfying the expression (1), a variation in amount of the closed pores 17 is reduced among the plurality of regions 11d. That is, the plurality of closed pores 17 are uniformly dispersed in the resin layer 16 of the second optical member 11.

Further, in two adjoining regions 11d, an average diameter of the closed pores 17 contained in one of the regions 11d is “d1,” and an average diameter of the closed pores 17 contained in the other region 11d is “d2,” the following expression (2) is preferably satisfied:

0.9×d2<d1<1.1×d2 (2)

By satisfying the expression (2), a variation in size of the closed pores 17 is reduced among the plurality of regions 11d.

Still further, in two adjoining regions 11d, a refractive index for a predetermined wavelength λ in one of the regions 11d is “n1(λ),” and a refractive index for the predetermined wavelength in the other region 11d is “n2(λ),” the following expression (3) is preferably satisfied. The predetermined wavelength λ is preferably any wavelengths in the target wavelength range of the diffractive optical element 1, and is, e.g., a wavelength at a d line.

0.9×n2(λ)<n1(λ)<1.1×n2(λ) (3)

By satisfying the expression (3), a variation in refractive index is reduced among the plurality of regions 11d.

Next, one example of a manufacturing method of the diffractive optical element 1 configured as described above will be briefly described. First, a mold having a reversed shape of the first diffraction grating 14 is prepared. The mold is filled with softened glass material. Then, the first optical member 10 is molded. Subsequently, the first optical member 10 is arranged in another mold so that the first diffraction grating 14 faces an inside of the mold. That is, the first diffraction grating 14 and the mold together form a cavity. The mold in which the first optical member 10 is arranged is filled with ultraviolet curable resin material. Consequently, the resin flows into valley portions of the first diffraction grating 14.

The ultraviolet curable resin material is formed by mixing an ultraviolet curable monomer with a pore forming agent (porogen) which is compatible with the ultraviolet curable monomer. The ultraviolet curable monomer reacts with ultraviolet and is changed into a polymer. The porogen used in this process is material which is compatible with a monomer, but is not compatible with a polymer. That is, in the cured ultraviolet curable resin material, the porogen is isolated from the polymer. After the ultraviolet curable resin material is cured by ultraviolet, a cleaning process for removing the porogen contained in the polymer is performed, and therefore the second optical member 11 made of the material containing many closed pores 17 is stacked on the first diffraction grating 14 of the first optical member 10. The second optical member 11 is molded, which includes the second diffraction grating 15 contacting the first diffraction grating 14. Note that the foregoing manufacturing method is one example, and any manufacturing methods can be applied as long as the diffractive optical element 1 can be manufactured.

The content of the porogen is adjusted, thereby adjusting the amount of the closed pores 17. In addition, the size of the porogen is adjusted, thereby adjusting the size of the closed pores 17.

As in the present embodiment, when using the diffractive optical element 1 for the interchangeable lens 200, the diffractive optical element 1 is targeted for white light, and therefore it is desired that wavelength dependency of diffraction efficiency is low. Thus, the diffractive optical element 1 preferably satisfies the following expression (4):

−6.30≦M≦−4.55 (4)

where M={n₁(λ₂)−n₂(λ₂)}/{n₁(λ₁)−n₁(λ₃)−n₂(λ₁)+n₂(λ₃)}, “n₁(λ)” represents a refractive index of the first optical member for incident light having a wavelength λ, “n₂(λ)” represents a refractive index of the second optical member for the incident light having the wavelength λ, “λ₁” is about 0.486133 μm, “λ₂” is about 0.587562 μm, and “λ₃” is about 0.656273 μm.

Specifically, in the expression (4), “λ₁” represents an F-line wavelength, “λ₂” represents a d-line wavelength, and “λ₃” represents a C-line wavelength. That is, a numerator of the fraction “M” is a difference between a reference refractive index (n₁(λ₂)) of the first optical member 10 and a reference refractive index (n₂(λ₂)) of the second optical member 11, and a denominator is a difference between a principal dispersion (n₁(λ₁)−n₁(λ₃)) of the first optical member 10 and a principal dispersion (n₂(λ₁)−n₂(λ₃)) of the second optical member 11. The “principal dispersion” is a difference between a refractive index at the F line and a refractive index at the C line. That is, “M” represents a ratio of an amount of change (difference) in reference refractive index between the first optical member 10 and the second optical member 11, to an amount of change (difference) in principal dispersion between the first optical member 10 and the second optical member 11. In the specification of the present disclosure, “M” is referred to as an “inter-material gradient.”

The wavelength dependency of the diffraction efficiency of the diffractive optical element 1 is changed depending on the inter-material gradient M. The first and second optical members 10, 11 are selected so that the expression (1) is satisfied, and then are used to produce the diffractive optical element 1. Thus, the diffraction efficiency of the diffractive optical element 1 can be uniformly high across an entire visible wavelength range (range in which a wavelength is about 0.400-0.700 μm). That is, the wavelength dependency of the diffraction efficiency across the entire visible wavelength range can be reduced, and an average value of the diffraction efficiency across the entire visible wavelength range (hereinafter referred to as an “average diffraction efficiency across visible wavelength”) can be improved.

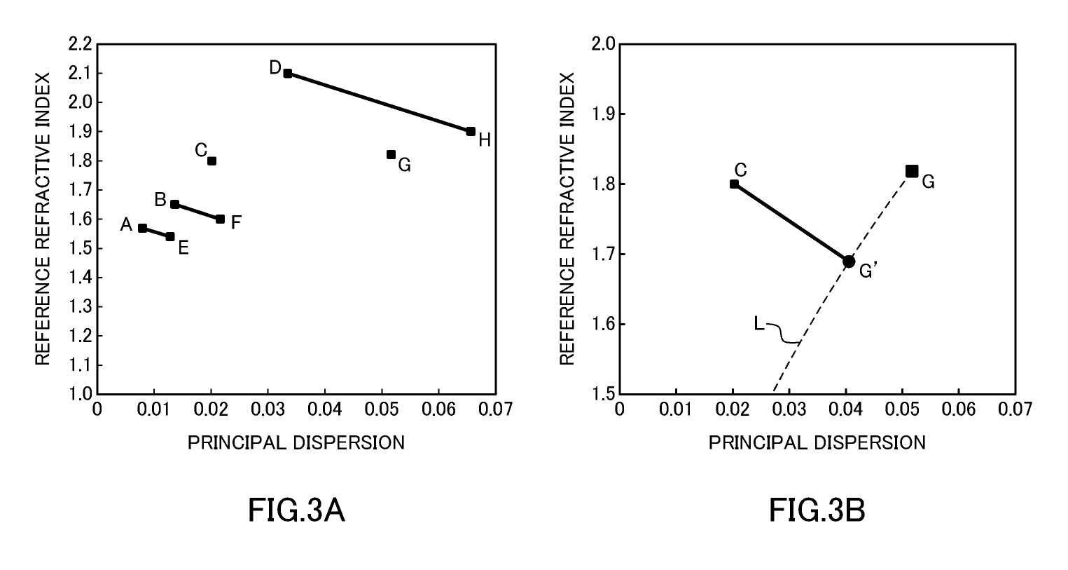

FIG. 3(a) is a graph illustrating combinations of the first and second optical members 10, 11, which are selected so as to satisfy the inter-material gradient M. The vertical axis of the graph of FIG. 3(a) is a reference refractive index (n(λd)), and the horizontal axis is a principal dispersion (n(λF)−n(λC)). Points A-D in FIG. 3(a) represent examples of materials used for the first optical member 10, and points E-H represent examples of materials used for the second optical member 11. Specific optical constants at the points A-H are shown in the following Table 1.

TABLE 1

| Material | Refractive Index n_{d} | Abbe Number ν_{d} |
|---|---|---|
| A | 1.57 | 71.2 |
| B | 1.65 | 47.9 |
| C | 1.8 | 39.6 |
| D | 2.1 | 32.9 |
| E | 1.54 | 42.1 |
| F | 1.6 | 27.7 |
| G | 1.82 | 15.9 |
| H | 1.9 | 13.7 |
| G′ | 1.69 | 17.0 |

FIG. 3(a) and Table 1 show the examples of the materials used for the first optical member 10 and the second optical member 11, and do not cover all kinds of materials used for the first optical member 10 and the second optical member 11.

A gradient of a line connecting between the points A and E is “−6.22,” and such a gradient is equivalent to the inter-material gradient M. The combination of the materials A and E satisfies the relationship based on the expression (4) regarding the inter-material gradient M. A gradient of a line connecting between the points B and F and a gradient of a line connecting between the points D and H are “−6.18” and “−6.20,” respectively. The combination of the materials B and F and the combination of the materials D and H also satisfy the relationship based on the expression (4) regarding the inter-material gradient M. In such a manner, the first and second optical members 10, 11 are selected so that the inter-material gradient M is a predetermined value, thereby realizing the diffractive optical element 1 having desired optical properties.

However, a gradient of a line connecting between the points C and G is “0.64,” and does not satisfy the expression (4). As in such a case, there may be no optical material of the second optical member 11, which satisfies the expression (4) in combination with the material C. That is, there may be no combination of optical materials, which satisfies predetermined conditions on the inter-material gradient M. For example, there is desired glass material, but there is no resin material corresponding to such glass material. Even if there is a combination of optical materials, which satisfies the predetermined conditions on the inter-material gradient M, the molding with such optical materials is difficult. For example, if selected glass material has a high molding temperature, the molding with such material is difficult. Further, even if there is a combination of optical materials, which satisfies the predetermined conditions on the inter-material gradient M, and with which the molding is easy, a refractive index difference between the two optical materials may be small. Typically, easily-moldable material often has a low refractive index. However, if materials having a low refractive index are combined together, a refractive index difference between such materials tends to be decreased. A smaller refractive index difference results in a higher diffraction grating. Consequently, the diffraction efficiency is degraded when light obliquely enters the diffraction grating, and therefore it is difficult to realize the desired optical properties.

As described above, the selection of the materials suitable for the diffractive optical element 1 has various limitations. That is, among actual optical materials, the degree of freedom of the material selection is low.

In the diffractive optical element 1 of the present embodiment, the plurality of pores are formed in the second optical member 11. Specifically, the second optical member 11 includes the plurality of closed pores 17. This changes the optical constants of the second optical member 11. Specifically, the effective refractive index of the second optical member 11 can be reduced.

FIG. 3(b) is a graph illustrating a change in optical constant by providing the pores in the optical member. A volume ratio of the pores to the optical member is increased, and therefore effective optical constants of the optical member approach optical constants of air. That is, the providing of the plurality of pores in the optical member can reduce the effective refractive index of the optical member. In this manner, the optical constants of one of the optical members of the diffractive optical element 1 is changed, and therefore the combination of the optical materials can be realized, which satisfies the predetermined conditions on the inter-material gradient M.

Specifically, the points C and G in FIG. 3(b) will be described as an example. The gradient of the line connecting between the points C and G does not satisfy the expression (4). That is, even if the materials C and G are combined, the diffractive optical element 1 having the desired optical properties cannot be realized. However, the pores are formed in the material G, thereby moving the point G on a curved line L in FIG. 3(b). That is, the material G may have optical constants corresponding to any points on the curved line L in FIG. 3(b). A volume ratio of the pores to the material G is adjusted, and therefore the optical constants of the material G can be freely adjusted within a range along the curved line L. For example, the optical constants of the material G can be adjusted to optical constants corresponding to point G′. The optical constants corresponding to the point G′ include a refractive index n_{d} of about 1.69 and an Abbe number v_{d} of about 17.0. A gradient of a line connecting between the points C and G′ is “−5.40,” and the combination of the materials C and G′ satisfies the expression (4). Consequently, the material C becomes available, which could not be used because there is no suitable material to be combined with the material C.

Thus, in the present embodiment, the plurality of pores are formed in the second optical member 11, thereby adjusting the optical constants of the second optical member 11. The first and second optical members 10, 11 having desired optical constants are stacked, thereby realizing the diffractive optical element 1 having a desired optical performance. That is, even if the optical material itself forming the second optical member 11 does not have the desired optical constants, the optical constants of the second optical member 11 can be adjusted to desired values to realize the diffractive optical element 1 having the desired optical performance by forming the pores in the second optical member 11. Consequently, the limitations when selecting the optical materials of the first and second optical members 10, 11 can be eliminated, thereby increasing the degree of freedom of the material selection.

The average diameter of the closed pores 17 is less than or equal to about 1/20 of the shortest wavelength in the wavelength range of incident light targeted for the diffractive optical element 1, thereby reducing the light scattering when light enters the second optical member 11.

Further, the second optical member 11 is divided into the plurality of regions 11d each corresponding to each of the recessed portions 15a. In two adjoining regions 11d, if the volume ratio of the closed pores 17 to one of the regions 11d is “p1,” and the volume ratio of the closed pores 17 to the other region 11d is “p2,” the closed pores 17 can be uniformly dispersed in the second optical member 11 by satisfying the expression (1). As a result, the optical constants can be uniform across the second optical member 11.

Still further, in two adjoining regions 11d, if the average diameter of the closed pores 17 contained in one of the regions 11d is “d1,” and the average diameter of the closed pores 17 contained in the other region 11d is “d2,” the light scattering can be uniform across the second optical member 11 by satisfying the expression (2).

Still Further, in two adjoining regions 11d, if the refractive index for the predetermined wavelength λ in one of the regions 11d is “n1(λ),” and the refractive index for the predetermined wavelength λ in the other region 11d is “n2(λ),” the refractive index for the wavelength λ can be uniform across the second optical member 11 by satisfying the expression (3).

### Second Embodiment

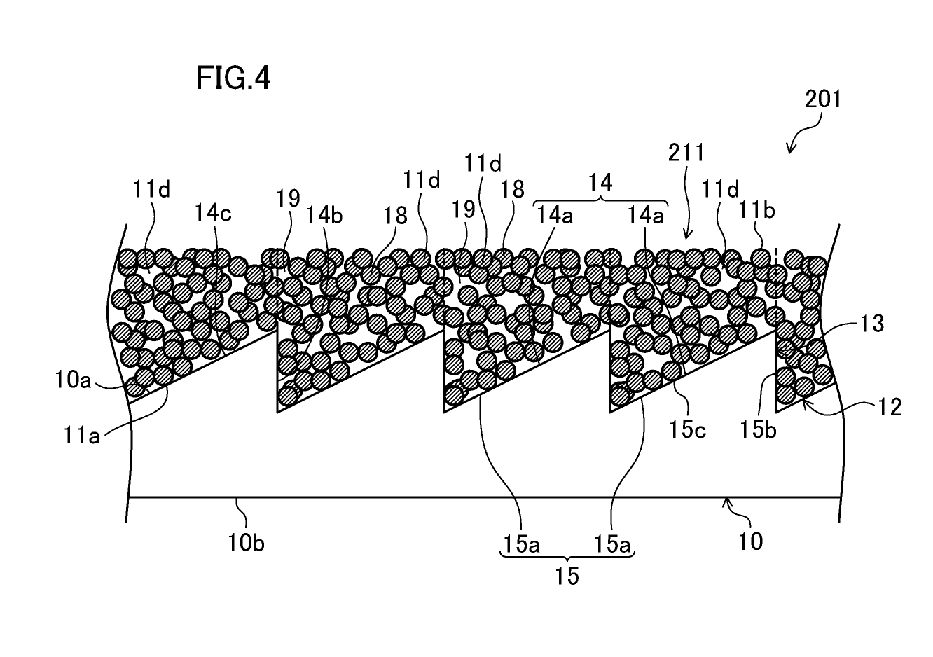

Next, a diffractive optical element 201 of a second embodiment will be described. FIG. 4 is a schematic cross-sectional view of the diffractive optical element 201 of the second embodiment.

The diffractive optical element 201 of the second embodiment includes a second optical member 211 having a configuration different from that of the second optical member 11 of the first embodiment. The same reference numerals as those used in the first embodiment are used to represent equivalent elements, and the description thereof is not repeated. Different configurations between the first and second embodiments will be mainly described.

Specifically, the second optical member 211 is formed by accumulating a plurality of particulates 18. In the second optical member 211, pores 19 are defined by the particulates 18.

The particulate 18 is made of, e.g., resin material. The particulate 18 is formed in substantially spherical shape. Some of the particulates 18 are formed in perfectly spherical shape, and other particulates 18 are bonded together in non-spherical shape.

The plurality of pores 19 are formed in the second optical member 211, thereby changing optical constants of the second optical member 211. Specifically, the plurality of pores 19 are formed in the second optical member 211, and therefore an effective refractive index of the second optical member 211 can be reduced as compared to a case where the pores 19 are not formed. That is, an increase in volume ratio of the pores 19 to the second optical member 211 (i.e., ratio of the volume of the pores 19 to the volume of the second optical member 11) reduces the effective refractive index of the second optical member 211. As will be described in detail later, this broadens a range of material selection of the second optical member 211, which is applicable to the diffractive optical element 201. Further, a range of material selection of the first optical member 10, which is applicable to the diffractive optical element 201 can be broadened.

An average diameter of the particulates 18 is preferably less than or equal to about 1/20 of the shortest wavelength in a wavelength range of incident light targeted for the diffractive optical element 201. For example, if a target wavelength of the diffractive optical element 201 is about 400-700 nm, the average diameter of the particulates 18 is preferably less than or equal to about 20 nm. According to such a configuration, light scattering can be reduced when light enters the second optical member 211. Alternatively, greater than or equal to about 95% of the particulates 18 contained in the second optical member 211 preferably have the diameter of less than or equal to about 1/20 of the shortest wavelength in the wavelength range of incident light targeted for the diffractive optical element 201. According to such a configuration, the light scattering can be also reduced when light enters the second optical member 211.

In a case where the second optical member 211 is divided into a plurality of regions 11d corresponding to unit structures (i.e., recessed portions 15a) of a second diffraction grating 15 along cylindrical planes concentric with an optical axis, if, in two adjoining regions 11d, an average diameter of the particulates 18 in one of the regions 11d is “v1,” and an average diameter of the particulates 18 in the other region 11d is “v2,” the following expression (5) is preferably satisfied:

0.9×v2<v1<1.1×v2 (5)

By satisfying the expression (5), a variation in size of the particulates 18 and a variation in size of the pores 19 among the plurality of regions 11d are reduced.

Next, one example of a manufacturing method of the diffractive optical element 201 will be briefly described. First, a mold having a reversed shape of a first diffraction grating 14 is prepared. The mold is filled with softened glass material. Then, the first optical member 10 is molded. Subsequently, the first optical member 10 is arranged in another mold so that the first diffraction grating 14 faces an inside of the mold. The second optical member 211 is formed by using a typical sol-gel method. Sol or gel containing resin material particulates is applied to the inside of the mold in which the first optical member 10 is arranged. In a state in which the sol or gel is applied to the mold, a thermal process is performed to remove solvent remaining inside the mold, and promotes densification. Thus, the resin material particulates are accumulated, thereby forming the second optical member 211 containing the pores 19. Consequently, the second optical member 211 is molded, which includes the second diffraction grating 15 contacting the first diffraction grating 14. Note that the foregoing manufacturing method is one example, and any manufacturing methods can be applied as long as the diffractive optical element 201 can be manufactured.

### Third Embodiment

Next, a diffractive optical element 301 of a third embodiment will be described. FIG. 5 is a schematic cross-sectional view of the diffractive optical element 301 of the third embodiment.

The diffractive optical element 301 of the third embodiment includes a second optical member 311 having a configuration different from that of the second optical member 11 of the first embodiment. The same reference numerals as those used in the first embodiment are used to represent equivalent elements, and the description thereof is not repeated. Different configurations between the first and third embodiments will be mainly described.

Specifically, the second optical member 311 includes a resin layer 16 and a plurality of hollow silica particulates 20 dispersed in the resin layer 16.

The hollow silica particulate 20 is a substantially spherical particulate made of silica. The hollow silica particulate 20 is formed with a closed pore so as to have a hollow shape. A hollow forms a pore. The hollow silica particulate 20 is one example of particulates having pores.

The second optical member 311 contains the hollow silica particulates 20, and therefore a plurality of closed pores can be formed in the second optical member 311. The formation of the plurality of closed pores in the second optical member 311 changes optical constants of the second optical member 311 as in the first embodiment. Specifically, an effective refractive index of the second optical member 311 can be reduced. In such a state, it is necessary to consider the presence of silica regarding the optical constants of the second optical member 311. Thus, as compared to a case where closed pores are simply formed in a second optical member, an effect that the effective refractive index of the second optical member 311 is reduced is less likely to be realized due to the silica content. However, the hollow silica particulates 20 are easily dispersed in the resin layer 16, and therefore there are merits such as easy manufacturing of the second optical member 311. By increasing a volume ratio of the pore to the hollow silica particulate 20, the hollow silica particulate 20 having an effective refractive index close to that of air can be formed. In such a manner, the effect that the effective refractive index is reduced as in the first and second embodiments can be realized.

In order to obtain the effective refractive index of the second optical member 311, an effective refractive index of the hollow silica particulate 20 is first obtained based on a volume ratio of the closed pore to silica in the hollow silica particulate 20. Subsequently, the effective refractive index of the entire second optical member 311 is obtained based on a volume ratio of the hollow silica particulates 20 to the resin layer 16.

Note that the particulate having the pore is not limited to the hollow silica particulate 20. Other kinds of particulate having a pore, such as mesoporous silica may be used.

An average diameter of the hollow silica particulates 20 is preferably less than or equal to about 1/20 of the shortest wavelength in a wavelength range of incident light targeted for the diffractive optical element 301. For example, if a target wavelength of the diffractive optical element 301 is about 400-700 nm, the average diameter of the hollow silica particulates 20 is preferably less than or equal to about 20 nm. According to such a configuration, light scattering can be reduced when light enters the second optical member 311. Alternatively, greater than or equal to about 95% of the hollow silica particulates 20 contained in the second optical member 311 preferably have the diameter of less than or equal to about 1/20 of the shortest wavelength in the wavelength range of incident light targeted for the diffractive optical element 301. According to such a configuration, the light scattering can be also reduced when light enters the second optical member 311.

Next, one example of a manufacturing method of the diffractive optical element 301 of the present embodiment will be briefly described. First, a mold having a reversed shape of a first diffraction grating 14 is prepared. The mold is filled with softened glass material. Then, a first optical member 10 is molded. Subsequently, the first optical member 10 is arranged in another mold so that the first diffraction grating 14 faces an inside of the mold. The mold in which the first optical member 10 is arranged is filled with ultraviolet curable resin material mixed with the hollow silica particulates 20. The pore is contained in the hollow silica particulate 20, and therefore the hollow silica particulates 20 may be uniformly dispersed in the ultraviolet curable resin material. Then, the ultraviolet curable resin material is irradiated with ultraviolet and is cured. Thus, the second optical member 311 made of the material containing many pores is stacked on the first diffraction grating 14 of the first optical member 10. Consequently, the second optical member 311 is molded, which includes a second diffraction grating 15 contacting the first diffraction grating 14. Note that the foregoing manufacturing method is one example, and any manufacturing methods can be applied as long as the diffractive optical element 301 can be manufactured.

### EXAMPLES

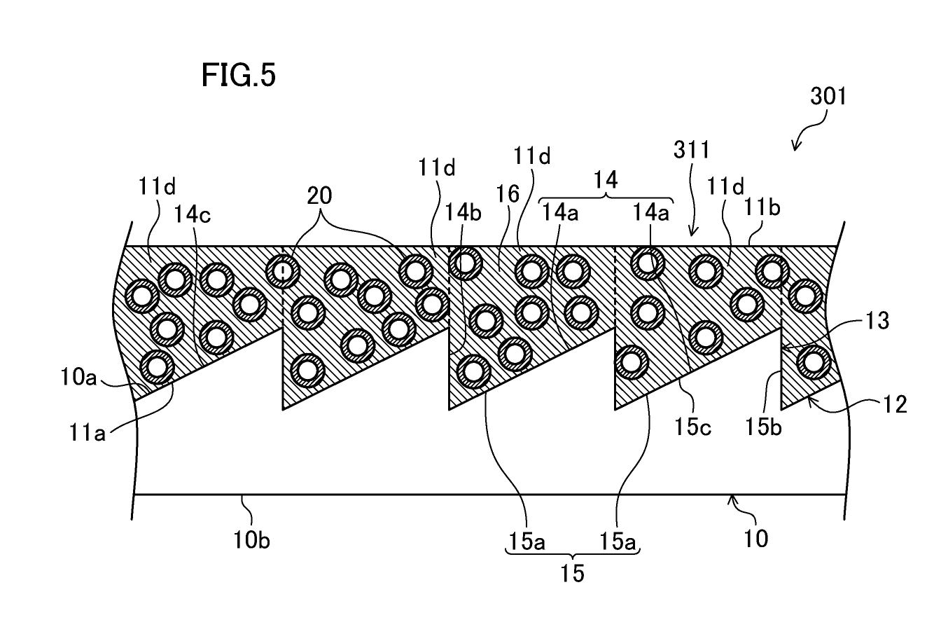

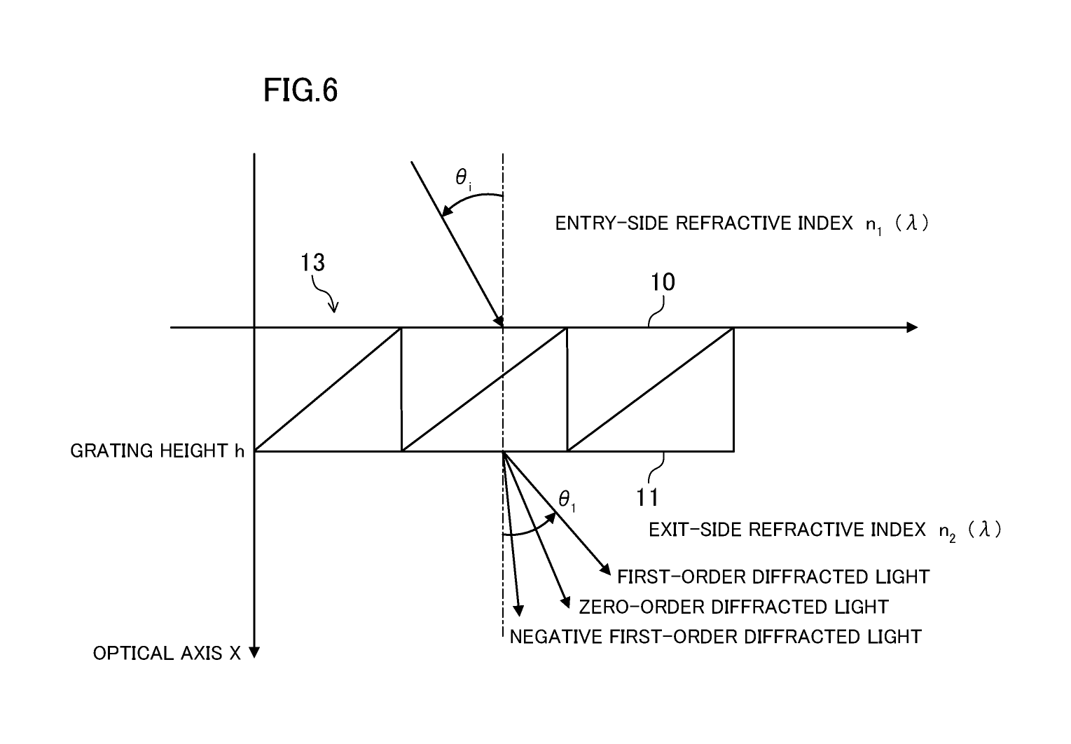

In the present example, diffractive optical element models formed by using various combinations of materials were assumed, and diffraction efficiencies of such models were obtained by a simulation. First, a method for obtaining the diffraction efficiency of the diffractive optical element will be described. FIG. 6 is a schematic cross-sectional view of a diffraction grating.

A diffraction grating 13 illustrated in FIG. 6 will be assumed. In such a case, the following expressions (6) and (7) are satisfied:

φ(λ)=(h/λ)×{n₁(λ)cos θₘ−n₂(λ)cos θᵢ} (6)

n₂(λ)sin θₘ=n₁(λ)sin θᵢ+mλ/P (7)

where “φ(λ)” represents a phase difference, “h” represents a grating height (μm), “λ” represents a wavelength (μm), “m” represents an order of diffraction, “n₁(λ)” represents a refractive index for a wavelength λ of the first optical member, “n₂(λ)” represents a refractive index for a wavelength λ of the second optical member, “θᵢ” represents an angle of incidence (degrees), “θₘ” represents a m-order diffraction angle (degrees), and “P” represents a grating pitch (cycle) (μm).

The phase difference φ(λ) is used to obtain diffraction efficiency ηₘ(λ) of m-order diffracted light for incident light having a wavelength λ, based on the following expression (8):

ηₘ(λ)=sin c²(φ(λ)−m) (8)

In order to obtain diffraction efficiency of first-order diffracted light for light incident in a direction parallel to an optical axis, θᵢ=0 and m=1 are assumed. P>>λ is typically satisfied. Thus, the expression (7) provides θₘ=0. Consequently, each of the expressions (6) and (8) provides:

φ(λ)=(h/λ)×{n₁(λ)−n₂(λ)} (9)

η₁(λ)=sin c²(φ(λ)−1) (10)

That is, the phase difference φ(λ) for each wavelength λ of a visible wavelength range can be obtained based on the expression (9) by changing the wavelength λ in the visible wavelength range. Further, by substituting the phase difference into the expression (10), diffraction efficiency η₁(λ) of first-order diffracted light for each wavelength λ of the visible wavelength range can be obtained. Then, the obtained diffraction efficiency η₁(λ) is averaged across the visible wavelength range, and therefore an average diffraction efficiency η across visible wavelength can be obtained, which is an average value of the diffraction efficiency η₁(λ) of first-order diffracted light in the visible wavelength range.

However, the expression (9) is a function not only for the wavelength λ, but also for the grating height h. The grating height h is determined depending on a blaze wavelength λ_{b}. That is, the blaze wavelength λ_{b} is equivalent to diffraction efficiency ηₘ(λ) of 1 (i.e., 100%), thereby providing φ(λ_{b})−m=0 based on the expression (8). This example is targeted for the first-order diffracted light, and therefore φ(λ_{b})=1 when m=1. When such a value is substituted into the expression (9), and the expression (9) is rearranged,

h=λ_{b}/{n₁(λ_{b})−n₂(λ_{b})} (11)

As for material, a refractive index n_{d} and an Abbe number v_{d} of which at a d line are given, a refractive index n(λ) for each wavelength λ (μm) can be calculated based on the following Hertzberger's expressions (12)-(14):

A(λ)=0.088927×λ²−1.294878+0.37349/(λ²−0.035)+0.005799/(λ²−0.035)² (12)

B(λ)=0.001255−0.007058×λ²+0.001071/(λ²−0.035)−0.000218/(λ²−0.035)² (13)

n(λ)=1+(n_{d}−1)×{1+B(λ)+(A(λ)/v_{d})} (14)

Thus, the blaze wavelength λ_{b} and the materials of the first and second optical members 10, 11 (i.e., a refractive index n₁(λ_{d}) and an Abbe number v_{d1} at a d line of the first optical member 10, and a refractive index n₂(λ_{d}) and an Abbe number v_{d2} at a d line of the second optical member 11) are first determined. Next, a refractive index n₁(λ_{b}) of the first optical member 10 and a refractive index n₂(λ_{b}) of the second optical member 11 for the blaze wavelength λ_{b} are obtained based on the expressions (12)-(14), and then such values are substituted into the expression (11) to obtain the grating height h. The obtained grating height h is substituted into the expression (9), and the wavelength λ is changed in the visible wavelength range. Then, the diffraction efficiency η₁(λ) of first-order diffracted light for each wavelength λ, is obtained based on the expression (10). At this point, the refractive index n₁(λ) of the first optical member 10 and the refractive index n₂(λ) of the second optical member 11 for each wavelength λ are obtained based on the expressions (12)-(14). Finally, the diffraction efficiency η₁(λ) of first-order diffracted light for each wavelength λ is averaged across the visible wavelength range to obtain the average diffraction efficiency η across visible wavelength.

Since pores are formed in the second optical member 11 in the present example, an effective refractive index is changed. A value of such a change is obtained based on the following Lorentz-Lorenz expression (15). The diffractive optical element 1 of the first embodiment in FIG. 2 will be described below as an example.

$${n}_{p} = \sqrt{\frac{1 + 2 ( 1 - {V}_{p} ) ( \frac{{n}_{b}^{2} - 1}{{n}_{b}^{2} + 2} )}{1 - ( 1 - {V}_{p} ) ( \frac{{n}_{b}^{2} - 1}{{n}_{b}^{2} + 2} )}} \qquad ( 15 )$$

where “nₚ” represents an effective refractive index of the second optical member 11, “n_{b}” represents a refractive index of the resin layer 16, and “Vₚ” represents a volume ratio of the closed pores 17 to the second optical member 11. Note that an expression similar to the expression (15) is applicable to the configuration of the second embodiment in FIG. 4. In such a case, “n_{b}” represents a refractive index of the particulate 18 made of resin, and “Vₚ” represents a volume ratio of the pores 19 to the second optical member 11. Further, the expression (15) is applicable to a case where the effective refractive index of the hollow silica particulate 20 of the third embodiment in FIG. 5 is obtained. In such a case, “nₚ” represents the effective refractive index of the hollow silica particulate 20, “n_{b}” represents a refractive index of silica, and “Vₚ” represents a volume ratio of the pore to the hollow silica particulate 20.

The effective refractive index of the second optical member 11 in the configuration of the third embodiment in FIG. 5 is obtained based on the following expression:

nₚ=n_{b}(1−Vₛ)+nₛ·Vₛ (16)

where “nₚ” represents an effective refractive index of the second optical member 11, “n_{b}” represents a refractive index of the resin layer 16, “nₛ” represents an effective refractive index (“nₚ” obtained based on the expression (15), which is the effective refractive index of the hollow silica particulate 20) of the hollow silica particulate 20, and “Vₛ” represents a volume ratio of the hollow silica particulates 20 to the second optical member 11.

The effective refractive index of the second optical member 11 was obtained based on the foregoing expressions, and materials by which a desired inter-material gradient M can be obtained were selected. Then, the diffraction efficiency of first-order diffracted light for each wavelength λ of the visible wavelength range was obtained based on the expression (8).

Examples of the diffractive optical element will be described below.

### First Comparative Example

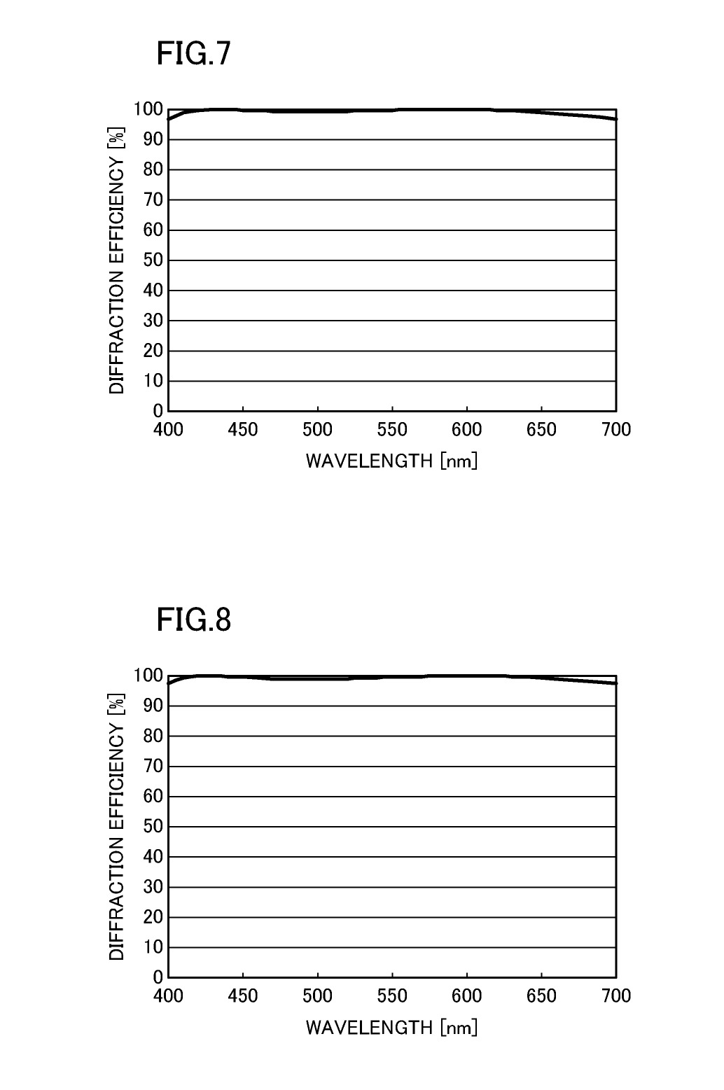

In a first comparative example, a first optical member 10 was made of glass (glass K-LaFn2 manufactured by Sumita Optical Glass Inc.) having a refractive index n₁(λ_{d}) of about 1.697 and an Abbe number v_{d1} of about 48.5 at a d line, and a second optical member 11 was made of ultraviolet curable resin having a refractive index n₂(λ_{d}) of about 1.6293 and an Abbe number v_{d2} of about 23.5 at the d line. A grating height was about 8.68 (μm). Based on the expression (8), diffraction efficiency of first-order diffracted light for each wavelength λ of a visible wavelength range was calculated. As illustrated in FIG. 7, the diffraction efficiency was favorable across the entire visible wavelength range. However, a molding temperature of the glass K-LaFn2 used for the first optical member 10 is relatively high. Specifically, it is necessary that a temperature at which a diffraction grating shape formed in a mold can be transferred is higher than or equal to about 650° C. Consequently, kinds of material of the mold for forming the first optical member 10 with the glass K-LaFn2 are limited, and therefore the diffractive optical element cannot be easily manufactured.

### Example 1-1

In example 1-1, a diffractive optical element was configured so that a second optical member 11 includes pores. A volume ratio of the closed pores 17 to the second optical member 11 was about 8%. Thus, the second optical member 11 had an effective refractive index n₂(λ_{d}) of about 1.5678 and an effective Abbe number v_{d2} of about 24.2 at a d line.

Next, as a first optical member 10 corresponding to the second optical member 11 having the reduced effective refractive index, glass (glass K-BaF8 manufactured by Sumita Optical Glass Inc.) was selected, which has a refractive index n₁(λ_{d}) of about 1.62374 and an Abbe number v_{d1} of about 47.1 at the d line. A grating height was about 10.61 (μm). As illustrated in FIG. 8, diffraction efficiency of first-order diffracted light for each wavelength λ of a visible wavelength range of example 1-1 was favorable as in the diffraction efficiency of the first comparative example. A diffraction grating shape formed in a mold can be transferred to the glass K-BaF8 used for the first optical member 10 at lower than or equal to about 550° C., and therefore the diffractive optical element can be easily manufactured as compared to the glass K-LaFn2 used in the first comparative example.

### Example 1-2

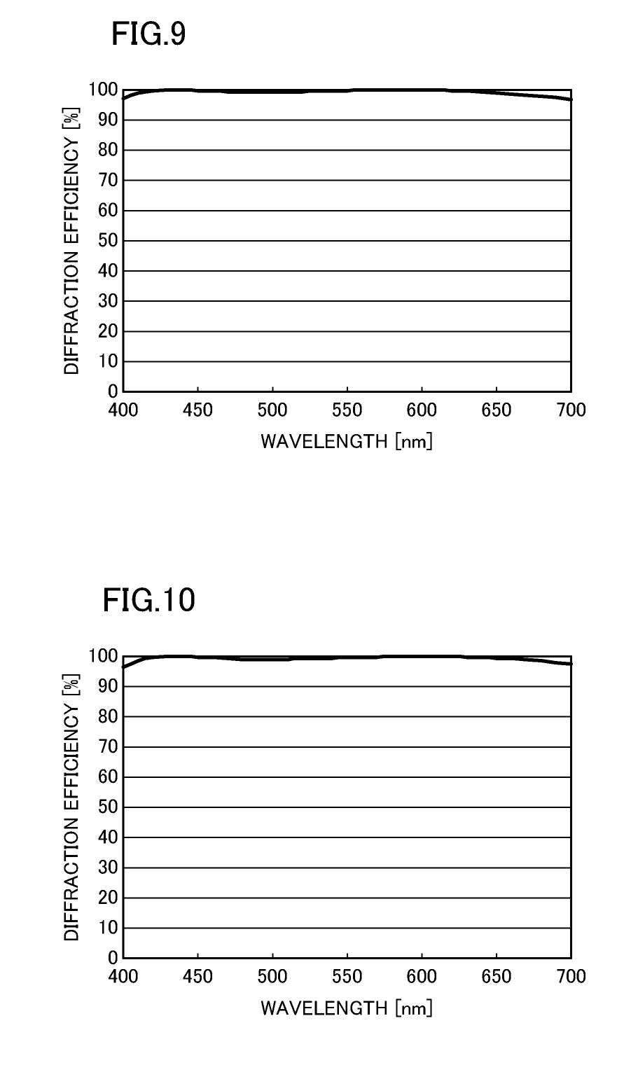

As example 1-2, a model of a diffractive optical element was prepared, in which the volume of the pores in the second optical member 11 of example 1-1 is increased. Specifically, a volume ratio of closed pores 17 to a second optical member 11 was about 19.5%. Thus, the second optical member 11 had an effective refractive index n₂(λ_{d}) of about 1.4841 and an effective Abbe number v_{d2} of about 25.1 at a d line. As a first optical member 10, glass (glass K-PG375 manufactured by Sumita Optical Glass Inc.) was selected, which has a refractive index n₁(λ_{d}) of about 1.5425 and an Abbe number v_{d1} of about 62.9 at the d line. A grating height was about 10.07 μm. As illustrated in FIG. 9, diffraction efficiency of first-order diffracted light for each wavelength of a visible wavelength range of example 1-2 was favorable as in the diffraction efficiency of the first comparative example. A diffraction grating shape formed in a mold can be transferred to the glass K-PG375 used for the first optical member 10 at lower than or equal to about 400° C., and therefore the diffractive optical element can be easily manufactured as compared to the glass K-BaF8 used in example 1-1.

As in examples 1-1 and 1-2, the volume ratio of the pores to the second optical member 11 is changed to adjust the effective refractive index, and therefore optical material which is different from the one selected before such adjustment can be selected as the optical material of the first optical member 10 corresponding to the effective refractive index. That is, material can be selected, which is advantageous to a level of difficulty in molding, cost, etc.

### Second Example

In a second example, a first optical member 10 was made of glass (glass K-VC79 manufactured by Sumita Optical Glass Inc.) having a refractive index n₁(λ_{d}) of about 1.61035 and an Abbe number v_{d1} of about 57.9 at a d line, and a second optical member 211 was made of ultraviolet curable resin having a refractive index n₂(λ_{d}) of about 1.5980 and an Abbe number v_{d2} of about 28.0 at the d line. Normally, in the material combination of the present example, an inter-material gradient M does not satisfy the expression (4), and therefore a diffractive optical element cannot be manufactured, in which diffraction efficiency is favorable across an entire visible wavelength range. Thus, pores were formed in the second optical member 211. The pores, a volume ratio of which to the second optical member 211 is about 5%, were formed in the second optical member 11. Thus, the second optical member 211 had an effective refractive index n₂(λ_{d}) of about 1.5616 and an effective Abbe number v_{d2} of about 28.5 at the d line. A grating height was about 12.18 μm. When calculating diffraction efficiency of first-order diffracted light for each wavelength λ of the visible wavelength range based on the expression (8), the favorable diffraction efficiency was obtained across the entire visible wavelength range as illustrated in FIG. 10.

### Third Example

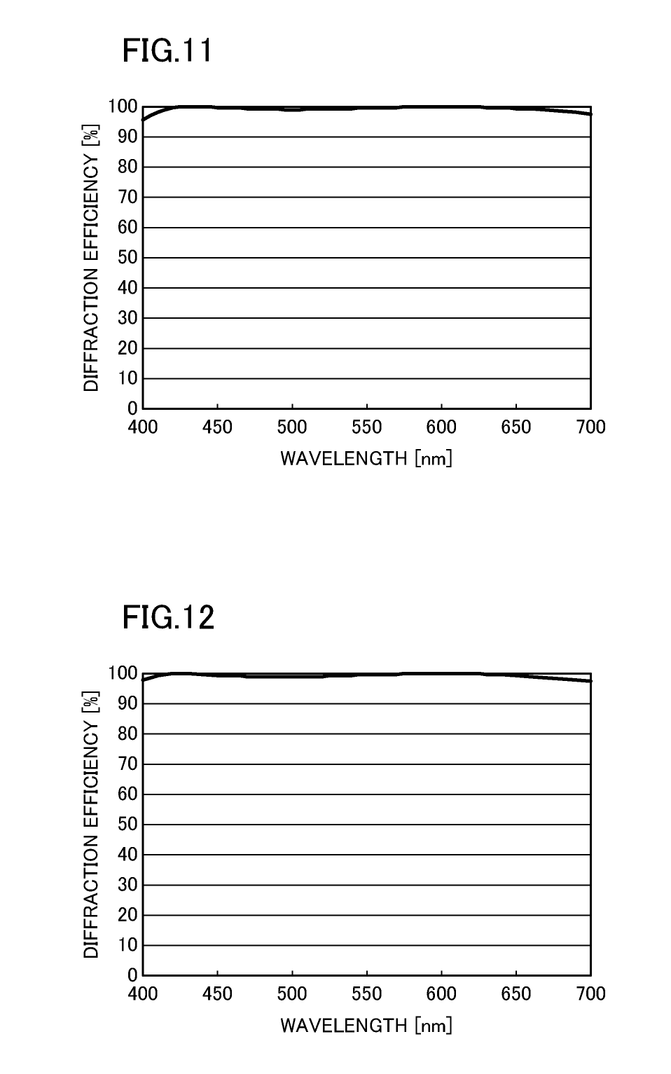

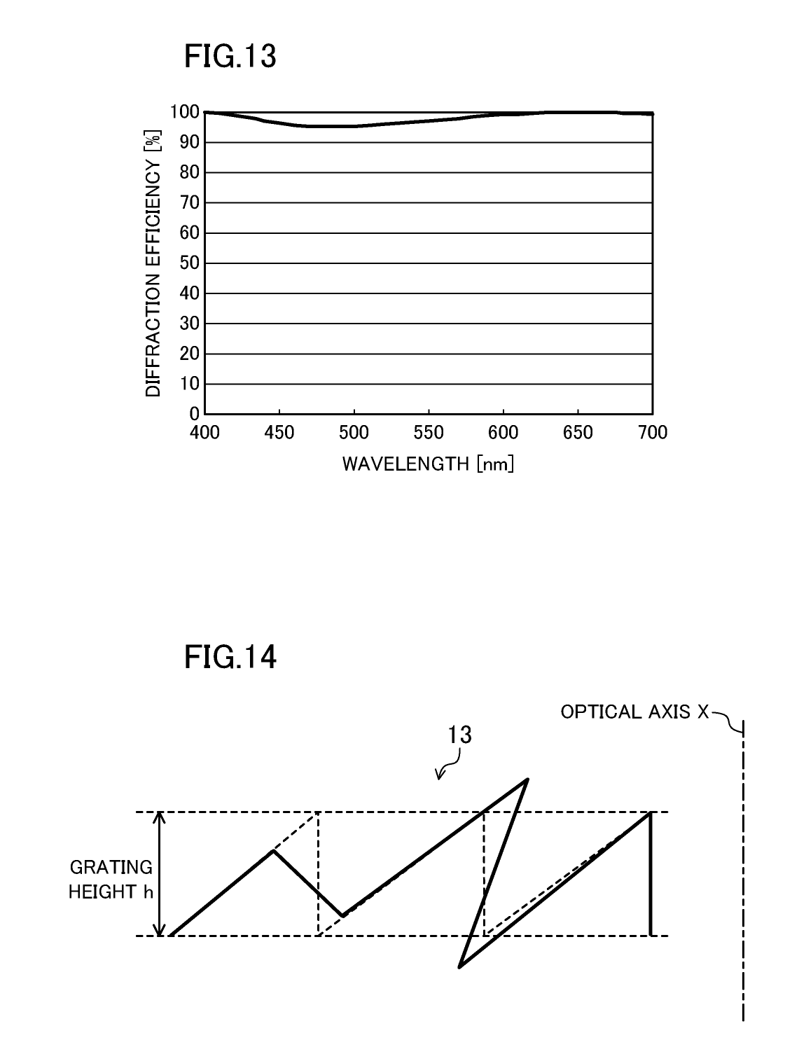

In a third example, a first optical member 10 was made of PMMA (polymethylmethacrylate) having a refractive index n₁(λ_{d}) of about 1.49 and an Abbe number v_{d1} of about 58.0 at a d line, and a second optical member 11 was made of ultraviolet curable resin having a refractive index n₂(λ_{d}) of about 1.5980 and an Abbe number v_{d2} of about 28.0 at the d line. Normally, in the material combination of the present example, an inter-material gradient M does not satisfy the expression (4), and therefore a diffractive optical element cannot be manufactured, in which diffraction efficiency is favorable across an entire visible wavelength range. Thus, pores were formed in the second optical member 11. In the present example, the pores, a volume ratio of which to the second optical member 11 is about 20.5%, were formed in the second optical member 11. Thus, the second optical member 11 had an effective refractive index n₂(λ_{d}) of about 1.4548 and an effective Abbe number v_{d2} of about 29.9 at the d line. A grating height was about 16.88 μm. When calculating diffraction efficiency of first-order diffracted light for each wavelength 2 of the visible wavelength range based on the expression (8), the favorable diffraction efficiency was obtained across the entire visible wavelength range as illustrated in FIG. 11.

### Fourth Example

In a fourth example, a first optical member 10 was made of glass (glass K-VC89 manufactured by Sumita Optical Glass Inc.) having a refractive index n₁(λ_{d}) of about 1.81 and an Abbe number v_{d1} of about 41.0 at a d line, and a second optical member 11 was made of glass (glass K-PSFn214 manufactured by Sumita Optical Glass Inc.) having a refractive index n₂(λ_{d}) of about 2.14352 and an Abbe number v_{d2} of about 17.8 at the d line. Normally, in the material combination of the present example, an inter-material gradient M does not satisfy the expression (4), and therefore a diffractive optical element cannot be manufactured, in which diffraction efficiency is favorable across an entire visible wavelength range. Thus, pores were formed in the second optical member 11. In the present example, the pores, a volume ratio of which to the second optical member 11 is about 26.5%, were formed in the second optical member 11. Thus, the second optical member 11 had an effective refractive index n₂(λ_{d}) of about 1.7336 and an effective Abbe number v_{d2} of about 21.9 at the d line. A grating height was about 7.77 μm. When calculating diffraction efficiency of first-order diffracted light for each wavelength λ of the visible wavelength range based on the expression (8), the favorable diffraction efficiency was obtained across the entire visible wavelength range as illustrated in FIG. 11.

### Fifth Example

In a fifth example, a first optical member 10 was made of glass (glass K-PFK85 manufactured by Sumita Optical Glass Inc.) having a refractive index n₁(λ_{d}) of about 1.48563 and an Abbe number v_{d1} of about 85.2 at a d line, and a second optical member 11 was made of hypothetical resin having a refractive index n₂(λ_{d}) of about 1.6293 and an Abbe number v_{d2} of about 23.5 at the d line. Normally, in the material combination of the present example, an inter-material gradient M does not satisfy the expression (4), and therefore a diffractive optical element cannot be manufactured, in which diffraction efficiency is favorable across an entire visible wavelength range. Thus, pores were formed in the second optical member 11. In the present example, the silica particulates are used, in which a volume ratio of the pore to the silica particulate is about 50%. The silica particulate has an effective refractive index nₛ(λ_{d}) of about 1.21 and an effective Abbe number v_{ds} of about 74.5 at the d line. Note that silica has a refractive index n_{b}(λ_{d}) of about 1.45 and an Abbe number v_{db} of about 68 at the d line. In the present example, the silica particulates were mixed with a second optical member 311 so that a volume ratio of the silica particulates to the second optical member 311 is about 47.0%. Thus, the second optical member 311 had an effective refractive index n₂(λ_{d}) of about 1.43 and an effective Abbe number v_{d2} of about 27.9 at the d line. A grating height was about 11.23 μm. When calculating diffraction efficiency of first-order diffracted light for each wavelength λ of the visible wavelength range based on the expression (8), the favorable diffraction efficiency was obtained across the entire visible wavelength range as illustrated in FIG. 12.

### Other Embodiments

The present disclosure may have the following configurations in the foregoing embodiments.

That is, in the foregoing embodiment, the diffractive optical element 1, 201, 301 is employed in the interchangeable lens 200, but the present disclosure is not limited to such a configuration. The diffractive optical element 1, 201, 301 may be applied as a lens element inside the camera 100. In addition, the present disclosure is not limited to the diffractive optical element 1, 201, 301 serving as the lens, and the diffractive optical element 1, 201, 301 may be applied for purposes other than the foregoing purpose.

In the foregoing embodiment, the first optical member 10 is made of glass material, and the second optical member 11 (211, 311) is made of resin material. However, the present disclosure is not limited to such a configuration. The first optical member 10 may be made of resin material, and the second optical member 11 (211, 311) may be made of glass material. Alternatively, both of the first and second optical members 10, 11 (211, 311) may be made of glass material or resin material. In addition, the materials of the first and second optical members 10, 11 (211, 311) are not limited to glass and resin, and the first and second optical members 10, 11 (211, 311) may be made of material such as transparent ceramic, which has transmission properties in a wavelength range to be used.

The diffractive optical element 1, 201, 301 is not limited to a two-layer structure. In a case where the diffractive optical element 1, 201, 301 has a structure with more than three layers, pores may be formed in at least one of adjoining two layers sandwiching the diffraction grating in such a multilayer structure.

In the foregoing embodiments, the pores are formed in the second optical member 11 (211, 311), but the present disclosure is not limited to such a configuration. For example, the pores may be formed in the first optical member 10 instead of the second optical member 11 (211, 311), or may be formed in both of the first and second optical members 10, 11 (211, 311). Note, however, that the pores are preferably formed in the optical member having a relatively smaller refractive index in order to increase the refractive index difference between the two optical members to be stacked. In such a case, nanocomposite mixed with particulates may be used for the optical member having a relatively larger refractive index. In order to decrease the refractive index difference, the pores may be formed in the optical member having the relatively larger refractive index.

The pore forming method is not limited to the methods in the foregoing embodiments. As long as the pores can be formed in the optical material, any methods can be employed. Note that glass or resin material itself may have porosity.

If there are various grating heights as illustrated in FIG. 14, a distance between an intersection point of a line parallel to the optical axis and one of the adjacent inclined surfaces, and an intersection point of the line and the other inclined surface is the grating height h.

The description of the embodiments of the present disclosure is given above for the understanding of the present disclosure. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

As described above, the technique disclosed herein is useful for the diffractive optical element in which the two optical members are stacked, and the diffraction grating is formed at the interface between the two optical members, and for the optical device including the diffractive optical element.

1. A diffractive optical element, comprising:
a first optical member in which a diffraction grating is formed; and
a second optical member in which a diffraction grating is formed,
wherein the first and second optical members are arranged in a state in which the diffraction gratings of the first and second optical members face each other, and
the second optical member includes a plurality of pores.

2. The diffractive optical element of claim 1, wherein
the pores are closed pores, and
the second optical member is made of resin or glass, and the plurality of closed pores are dispersed in the second optical member.

3. The diffractive optical element of claim 1, wherein
the second optical member is made of porous resin or glass.

4. The diffractive optical element of claim 2, wherein
the closed pores are spherical, and
an average diameter of the closed pores is less than or equal to about 1/20 of the shortest wavelength in a wavelength range of incident light targeted for the diffractive optical element.

5. The diffractive optical element of claim 2, wherein
the closed pores are spherical, and
greater than or equal to about 95% of the closed pores contained in the second optical member have a diameter of less than or equal to about 1/20 of the shortest wavelength in the wavelength range of incident light targeted for the diffractive optical element.

6. The diffractive optical element of claim 1, wherein
the second optical member is formed of a plurality of accumulated particulates, and the pores are defined by the particulates.

7. The diffractive optical element of claim 6, wherein
an average diameter of the particulates is less than or equal to about 1/20 of the shortest wavelength in the wavelength range of incident light targeted for the diffractive optical element.

8. The diffractive optical element of claim 6, wherein
greater than or equal to about 95% of the particulates contained in the second optical member have a diameter of less than or equal to about 1/20 of the shortest wavelength in the wavelength range of incident light targeted for the diffractive optical element.

9. The diffractive optical element of claim 1, wherein
the second optical member is made of resin or glass which contains particulates having pores.

10. The diffractive optical element of claim 9, wherein
an average diameter of the particulates is less than or equal to about 1/20 of the shortest wavelength in the wavelength range of incident light targeted for the diffractive optical element.

11. The diffractive optical element of claim 9, wherein
greater than or equal to about 95% of the particulates contained in the second optical member have a diameter of less than or equal to about 1/20 of the shortest wavelength in the wavelength range of incident light targeted for the diffractive optical element.

12. The diffractive optical element of claim 1, wherein,
when the second optical member is divided into a plurality of regions corresponding to unit structures of the diffraction grating along cylindrical planes concentric with an optical axis, if, in two adjoining regions, a volume ratio of the pores to one of the regions is “p1,” and a volume ratio of the pores to the other region is “p2,” the following expression (1) is satisfied:
0.9×p2<p1≦1.1×p2 (1)

13. The diffractive optical element of claim 2, wherein,
when the second optical member is divided into a plurality of regions corresponding to unit structures of the diffraction grating along cylindrical planes concentric with an optical axis, if, in two adjoining regions, an average diameter of the closed pores contained in one of the regions is “d1,” and an average diameter of the closed pores contained in the other region is “d2,” the following expression (2) is satisfied:
0.9×d2≦d1<1.1×d2 (2)

14. The diffractive optical element of claim 1, wherein,
when the second optical member is divided into a plurality of regions corresponding to unit structures of the diffraction grating along cylindrical planes concentric with an optical axis, if, in two adjoining regions, a refractive index for a predetermined wavelength λ in one of the regions is “n1(λ),” and a refractive index for the predetermined wavelength λ in the other region is “n2(λ),” the following expression (3) is satisfied:
0.9×n2(λ)<n1(λ)<1.1×n2(λ) (3)

15. The diffractive optical element of claim 6, wherein,
when the second optical member is divided into a plurality of regions corresponding to unit structures of the diffraction grating along cylindrical planes concentric with an optical axis, if, in two adjoining regions, an average diameter of the particulates in one of the regions is “v1,” and an average diameter of the particulates in the other region is “v2,” the following expression (4) is satisfied:
0.9×v2<v1<1.1×v2 (4)

16. An optical device, comprising:
an optical imaging system for focusing light bundles on a predetermined surface,
wherein the optical imaging system has the diffractive optical element of claim 1.

17. The diffractive optical element of claim 9, wherein,
when the second optical member is divided into a plurality of regions corresponding to unit structures of the diffraction grating along cylindrical planes concentric with an optical axis, if, in two adjoining regions, an average diameter of the particulates in one of the regions is “v1,” and an average diameter of the particulates in the other region is “v2,” the following expression (4) is satisfied:
0.9×v2<v1<1.1×v2 (4)
